(19) United States
(12) Patent Application Publication
(10) Pub. No.: US 2025/0203011 A1
(43) Pub. Date: Jun. 19, 2025

(54) DEVICE FOR FORMING A COMMUNICATION AND CONTROL ENVIRONMENT FOR A TECHNICAL WORK ENVIRONMENT

(71) Applicant: Georg-August-Universität Göttingen Stiftung Öffentlichen Rechts Universitätsmedizin, Göttingen (DE)

(72) Inventor: Martin FRIEDRICH, Göttingen (DE)

(73) Assignee: Georg-August-Universität Göttingen Stiftung Öffentlichen Rechts Universitätsmedizin, Göttingen (DE)

(21) Appl. No.: 18/717,349

(22) PCT Filed: Dec. 9, 2021
(86) PCT No.: PCT/EP2021/085107

§ 371 Date: Jun. 6, 2024

(51) Int. Cl. H04M 3/56; H04R 27/00

(52) U.S. Cl. CPC H04M 3/568; H04R 27/00; H04R 2227/001; H04R 2227/009; H04R 2420/01

(57) ABSTRACT

An apparatus for forming a computerized communication environment for a technical working environment, comprising:

A mixing device to which a plurality of devices are connected, the plurality of devices comprising:

a plurality of intercom devices with a microphone and an audio output, each of which is assigned to a person in the technical working environment, preferably a surgical operating room;

wherein

the mixing device with the plurality of intercoms controls, for each pair of two intercoms connected to the mixing device, whether and in which direction a flow of information is enabled between the two connected intercoms;

wherein a control matrix is provided for controlling the flow of information, the matrix having a matrix entry defining the flow of information for each pair of devices connected to the mixing device, the device further comprising:

a measuring microphone for measuring the ambient sound, which measures the sound level in the room; and wherein the mixing device comprises:

a computer-implemented control program executed by the mixing device, which dynamically adapts the matrix entries to the current situation in the technical working environment depending on the data supplied to the mixing device by the connected devices, the device having:

a gate for each of the microphones of the intercom devices, which can amplify or suppress the sound entering one of the microphones of the intercom devices for transmission to the audio outputs of other intercom devices;

whereby the control program is designed in such a way that the amplification or suppression of the sound entering at a microphone and to be output to the audio outputs of the other intercom devices is dynamically adjusted by the gate depending on the analysis of the ambient sound measured by the measuring microphone.

### CROSS-REFERENCE TO RELATED APPLICATION

This application is a U.S. National Stage filing under 35 U.S.C. § 371 of International Patent Application No. PCT/EP2021/085107, filed Dec. 9, 2021.

### BACKGROUND

When working in a technical working environment such as an operating room, one problem is that many people and devices involved have to be coordinated and information has to be exchanged, evaluated and action decisions made between the people and apparatuses involved.

Nowadays, this task is still largely carried out by the people involved by means of voice communication without machine support.

To optimize communication between the people involved, DE 10 2015 205 463 A1 proposes using a mixer and intercom units connected to it to create a program-controlled audio environment that can be used to form signal groups, for example. A matrix determines which participants can communicate with each other and in which direction. For example, hierarchy levels can be mapped in the matrix.

Overlapping groups are also provided. Threshold values are disclosed above which information is forwarded or not forwarded. Directional information is also measured and used to control the audio output.

However, the matrix that controls the communication in DE 10 2015 205 463 A1 is essentially static. It is therefore an object of the invention to further develop the device from DE 10 2015 205 463 A1 in such a way that it has greater flexibility.

### SUMMARY

According to one aspect, the invention comprises an apparatus for forming a computer-enabled communication environment for a technical working environment, comprising:

A mixing device to which a plurality of devices are connected, the plurality of devices comprising:
a plurality of intercom devices with a microphone and an audio output, each of which is assigned to a person in the technical working environment, which is preferably a surgical operating room;
wherein
the mixing device with the plurality of intercoms controls, for each pair of two intercoms connected to the mixing device, whether and in which direction a flow of information is enabled between the two connected intercoms;
wherein a control matrix is provided for controlling the flow of information, the matrix having a matrix entry defining the flow of information for each pair of devices connected to the mixing device, the apparatus further comprising:
a measuring microphone for measuring the ambient sound, which measures the sound level in the room; and wherein the mixing device comprises:
a computer-implemented control program executed by the mixing device, which dynamically adapts the matrix entries to the current situation in the technical working environment depending on the data supplied to the mixing device by the connected devices, the mixing device comprising:
a gate for each of the microphones of the intercom devices, which can amplify or suppress the sound entering one of the microphones of the intercom devices for transmission to the audio outputs of other intercom devices;
wherein the control program is adapted such that the amplification or suppression of the sound entering at a microphone and to be output to the audio outputs of the other intercom devices is dynamically adjusted by the gate depending on the analysis of the ambient sound measured by the measuring microphone.

In this way, the device can react dynamically to changing situations in the technical working environment and adapt the signal flow accordingly. In particular, an audio environment can be created in which a user is provided with a dynamically adapted and optimized audio environment via his audio output.

According to an embodiment, the mixing device controls the gate on at least one of the intercom devices in such a way that it forwards the incoming sound to audio outputs of the other intercom devices when it is at or above a certain minimum sound level, wherein the minimum sound level is adjusted depending on the sound level of the room measured by the measuring microphone.

This dynamic adaptation ensures a sufficient signal distance between a user's speech and the ambient sound, which improves the quality of communication.

According to one embodiment, a user's speech is fed into his own audio output if it has the minimum sound level and is forwarded to the audio outputs of the other users.

In this way, the user notices when his microphone is “muted” and speaks louder, if necessary, in order to reach the dynamically adjusted minimum sound level.

According to an embodiment, the mixing device further comprises:
an analysis device for spectral analysis of the sound arriving at the measuring microphone, wherein
the mixing device is adapted such that when a predetermined spectral pattern is recognized by the gate of an intercom device, one or more spectral components corresponding to the recognized spectral pattern are amplified or suppressed.

In this way, by adapting dynamically to the ambient sound unwanted signals can be suppressed and desired signals can be amplified.

According to an embodiment, the mixing device further comprises: A device for feeding the ambient sound received by the measurement microphone into the audio output of one or more of the intercom devices.

In this way, the user can perceive the real ambient sound in the protected audio environment if desired or necessary, and he may step out of the protected environment.

According to one embodiment, the sound level at which the ambient signal is fed into the audio output is dynamically adjusted in response to a request from the user or an external trigger signal detected by an analyzer of the mixing device.

This enables an adaptive feeding of the natural audio environment in response to a user request or an external signal as a triggering event.

According to one embodiment, an individual hearing correction curve is stored in the device for one or more users.

In this way, the device can implement a user-specific hearing aid in addition to its other functionality.

According to an embodiment, the technical working environment comprises one of the following:
a surgical operating room;
a production room in an industrial manufacturing facility;
a laboratory for the scientific or industrial analysis of chemical or physical processes or substances,
a control room for monitoring or controlling an industrial production process,
an open-plan office,
a conference environment.

According to one embodiment, the matrix data is changed when the incoming signals from connected devices in the mixing device indicate a trigger signal. This makes it possible to create a dynamically adaptable device that adapts to changing conditions.

According to an embodiment, the control program comprises information about the timing of the operation in the operating room, and based on this information, when an input signal of the sensor data indicates a trigger event representing an occurrence of an event in the timing of the operation, the control matrix is adjusted.

Representing the operation schedule enables dynamic adaptation of the control matrix to the respective situation in the operating room, depending on the progress of the operation, and it is possible to react automatically according to the course of the operation.

Based on this information, the matrix data can be changed when the signals received in the mixing device from connected devices indicate that a certain point in the time sequence has been reached.

For example, signaling a certain surgical step, such as requesting the stapler, can indicate that the surgery is about to end and, by adapting the matrix elements, trigger the request for personnel to use the positioning aid.

According to an embodiment, one of the following serves as a trigger signal:
The reaching of a signal value in one or more sensor data indicating that a specific point in the time sequence has been reached;
the reaching of a threshold value in one or more sensor data;
the detection of a keyword or key signal in a recorded acoustic signal; an input from the user to learn a new situation.

In this way, various adaptations of the control matrix and thus the functionality of the device to changing external conditions can be implemented.

In one embodiment, the control program is implemented in whole or in part by means of a neural network that receives the signals from the plurality of sensors as input and supplies the control matrix as output. The neural network is preferably trained using data from real operating situations and thus continues to adapt to the needs of the user and to new situations.

In an embodiment, the input signals of the control matrix comprise speech signals which are detected by means of speech recognition and examined for key words, wherein a key word represents a trigger signal.

In this way, the control matrix can be customized using voice control.

In one embodiment, the connected sensors identify the function of a user within a user group, in particular by means of a barcode or QR code, and based on the function of the user, only those data are transmitted from the mixing device to the user that are relevant according to his function and a hierarchy or function chart.

### BRIEF DESCRIPTION OF THE DRAWINGS

FIG. 1 schematically shows a device according to an embodiment.

FIG. 2 illustrates the functionality of the device and a control matrix according to an embodiment.

### DETAILED DESCRIPTION

In the following, the present invention will be described with reference to the accompanying drawings by means of exemplary embodiments.

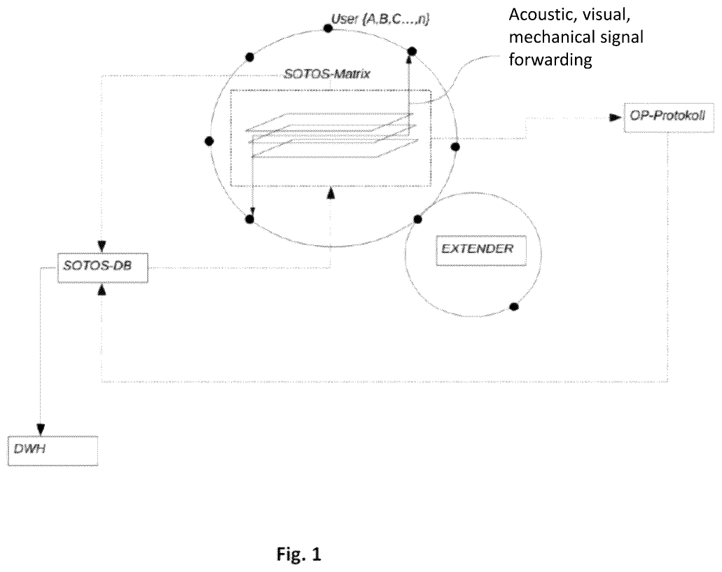

FIG. 1 schematically shows a device according to an embodiment of the invention. The circular element in the center of FIG. 1 is a mixing device to which intercom devices (not shown) of a plurality of users A, B, C, . . . n are connected.

The mixing device controls for each pair of connected intercom devices whether and in which direction a flow of information is enabled between the two connected intercom devices. To control the information flow, a control matrix is provided, referred to as the SOTOS matrix in FIG. 1, which has a matrix entry for each pair of devices connected to the mixing device and defines the information flow.

The device also has a measurement microphone, not shown, for measuring the ambient sound, which measures the sound level in the room.

According to an embodiment, the mixing device receives sensor data, for example on the condition of the operating room (air pressure, temperature, humidity, possibly the room geometry measured by means of e.g. LIDAR), but in particular also the input signals from the microphones of the intercom devices and the measuring microphone.

The mixing device can, for example, include active and/or passive filters or filters implemented using Al. The input signals are processed by the mixer by means of the control matrix and output signals are issued as a result, e.g. as voice signals as specified by the control matrix as a controlled signal flow to the users via the intercom devices, but according to embodiments for example also as alarm signals, as music, etc., Further elements such as the SOTOS-DB, an extender or an OP protocol can be provided and are described later.

The intercom devices are preferably a combination of headphones which are as soundproof as possible (over-the-ear or in-ear) and which shield the wearer as good as possible from ambient noise. Such headphones are preferably combined with a microphone to form a headset, whereby the microphone is preferably a directional microphone whose directional characteristic is directed towards the user. In this way, a “protected audio experience space” can be created for the user, which only provides each user with those audio signals that are intended for him according to the controlling by the mixing device.

The intercoms, one for each user in the operating room, are connected to the mixing device as mentioned above. The mixing device then controls whether and in which direction a flow of information is enabled between a pair of connected intercoms. To control the flow of information, a control matrix is provided (SOTOS matrix in FIG. 1), which has a matrix entry for each pair of intercom devices connected to the mixing device and which defines the flow of information.

The device also has a measuring microphone for measuring the ambient sound, which measures the sound level in the room. The mixing device in turn has a computer-implemented control program executed by the mixing device, which dynamically adapts the matrix entries to the current situation in the technical working environment depending on the data supplied to the mixing device by the connected devices. The measuring microphone is preferably positioned centrally in the room (e.g. on the ceiling) and is also sensitive to infrasound (<10 Hz) and supersonic sound (>20 kHz) in order to be able to detect background noise in this frequency range.

To adapt the information flow via the adaptation of the matrix entries, a gate is provided for each of the microphones of the intercom devices, which can amplify or suppress the sound entering the microphone of the intercom devices for transmission to the audio outputs of other intercom devices. The control program adapted in such a way that the amplification or suppression of the sound entering a microphone and to be output to the audio outputs of the other intercom devices is dynamically adjusted by the gate depending on the analysis of the ambient sound measured by the measuring microphone.

In this way, it is possible to react dynamically to a change in the ambient sound.

For example, in one embodiment, the mixing device controls the microphone gate on at least one of the intercom devices in such a way that it only forwards the incoming sound to the audio outputs of the other intercom devices once a certain minimum sound level has been reached. The minimum sound level is adjusted depending on the sound level of the room measured by the measuring microphone. If, for example, the ambient sound level increases, the minimum sound level at the microphone of the intercom device is increased and the user's speech is only forwarded to the audio outputs of the other users when a higher speech volume is reached. In this way, it can be ensured that the forwarded audio information or the forwarded speech maintains a minimum signal distance from the ambient sound, which improves the quality of communication.

According to one embodiment, a user's speech is fed into his own audio output if it reaches the minimum sound level and is forwarded to the audio outputs of other users.

In this way, the user receives feedback as to whether his speech reaches the minimum sound level in order to be forwarded. Depending on the feedback, he can then speak louder if necessary to ensure that he reaches the minimum sound level and that the other users can hear them. Only when he reaches the minimum sound level, his speech is passed on, below his microphone is “muted” so that his speech cannot be heard by other users. This ensures a high quality of communication, particularly in environments with variable ambient noise or mobile users whose location change.

According to one embodiment, the “gate” can function as a conventional “noise gate”, which completely passes or completely blocks the incoming sound at the microphone to the audio output of one or more of the other intercom devices. This means that the gate is either “on” or “off”, depending on the measured ambient sound or ambient sound pressure measured by the measurement microphone.

In addition to a pure “on” or “off”, in one embodiment the gate can amplify or suppress the input signal depending on the input signal strength at the measuring microphone or the microphone of the intercom device, possibly also in a non-linear relationship between amplification/suppression and input signal strength. This allows the dynamic range of the input signal to be increased (enhancer function) or reduced (compressor function). According to an embodiment, the gate can also perform a limiter function, which limits the output to a maximum signal strength. Additionally or alternatively, the output audio signal can be regulated to a certain minimum signal strength in order to ensure good audibility. By combining one or more of these gate functions, the voice quality at the audio outputs can be optimally adjusted.

According to an embodiment, the device comprises an analysis device for spectral analysis of the incoming sound at the measuring microphone. The mixing device is adapted such that when a predetermined spectral pattern is recognized by the gate of an intercom device, one or more spectral components corresponding to the recognized spectral pattern are amplified or suppressed.

In this way, unwanted noises can be suppressed by dynamically adjusting the control matrix. For example, the noise when opening a sterile package has a characteristic spectral component above 22 kHz. The corresponding pattern is stored in the mixing device according to one embodiment. If the spectral analysis device detects such an unwanted signal in the sound of the measuring microphone, the gate of the microphone of the intercom device can either suppress or filter out the unwanted signal component. Alternatively, it can completely mute the microphone of the intercom device if spectral suppression is not sufficiently effective. Once the unwanted noise has ceased, the suppression or muting can be canceled again.

In addition to complete suppression of the unwanted noise, only partial suppression can also be used instead. For example, a saw in a surgical operating room has a characteristic frequency spectrum in the 5-8 KHz range. If this part of the spectrum is detected in the input sound, the control matrix can be adapted so that the frequency components of the sawing noise are slightly suppressed or attenuated as part of an equalizer control. This reduces the disturbing effect of the noise, but it is still perceptible.

In addition to suppressing unwanted noises, the mixing device can also be designed to amplify important or desired noises that should be easily audible. For example, an electronic knife (eKnife) in the operating room has a characteristic spectral component at 507 Hz. If this is detected, it can be specifically amplified by the mixing device for individual users, e.g. the surgeon. This can be accompanied by simultaneous slight suppression of other spectral components such as speech. In this way, the perceptibility of important sounds can be enhanced for the user.

The measurement microphone, whose signal triggers the dynamic adjustment of the control matrix, can be a microphone located in the room for measuring the ambient sound or the microphone of the user's intercom device. The measurement microphone can be different depending on the adaptation to be performed. For example, a room microphone can be used to measure the ambient sound to adjust the minimum level of the intercom device. To identify the tearing open of a sterile package and subsequent suppression of the sound or muting of the microphone of the intercom device, on the other hand, the microphone of an intercom device can be used.

According to one embodiment, the mixing device has a means for feeding the ambient sound received up by a measuring microphone into the audio output of one or more of the intercom devices. The ambient sound can thus be fed to the user in order to reproduce a “normal external sound”.

Preferably, the sound level at which the ambient signal is fed into the audio output is dynamically adjusted in response to a request from the user or an external trigger signal detected by an analysis device of the mixing device. In this way, for example, a user can “exit” the protected audio environment on request (e.g. by pressing a button) without removing the headphones. A specific recognized signal, e.g. an alarm signal, can be used as an external trigger signal.

Overall, the mixing device and the control matrix can be used to generate any desired and dynamically customizable audio environments that are defined in terms of who hears what and whom, and how.

According to one embodiment, the measurement microphone for measuring the ambient sound is a microphone that is preferably mounted centrally in the room, for example on the ceiling, and is separate from the microphones of the intercom devices. However, according to one embodiment, the microphone of one or more intercom devices can additionally or alternatively function as a measurement microphone.

According to an embodiment, an individual hearing correction curve is stored in the device for one or more users. The audio output on the user's intercom device is then controlled by the mixing device in such a way that the audio signal output to the user is adapted according to the stored hearing correction curve. In this way, the device effectively implements a hearing aid adapted for the respective user.

Further embodiments are described below, the features of which may be implemented in addition to or as an alternative to the features described so far.

According to a further embodiment, the signal processing and the control matrix can be optimized by means of an optimization module via feedback from the users. For example, certain frequency-dependent amplifications or suppressions can be modified by modifying the associated frequency response of a filter or amplifier of a gate.

Using the mixing device described above, a pool of preferably active acoustic filters for implementing the gates can be used to reproduce or modify precisely described acoustic conditions in such a way that undesired frequency components are suppressed or others (desired or missing) are enhanced. The (active) filter adapts dynamically to the sound characteristics. For example, noise can be defined in detail, recorded and automatically filtered using an FFT. Furthermore, an Al filter is provided as a component of the active filter according to an embodiment, which reacts to the needs of the team members with the help of neural networks and provides input for the active filters. This can be used, for example, to generate effects that improve hearing and speech comprehension as well as effects of automated “listening” by offsetting runtime differences between different microphone settings in the team. The Al filter can be actively stimulated by the user using a type of “potentiometer” as an “optimizer” and/or learned through the experience of the team members.

In this way, not only can the acoustic signal flow between users be controlled via the intercom devices, but it can also be adaptively adjusted and improved.

According to an embodiment, such an adaptation of the functionality to new conditions is accompanied by an adaptation or change of the matrix data of the control matrix. This can be triggered by a “trigger event” that causes such an adaptation of the matrix data. A trigger event can be an input from the user, for example to “learn” a new situation. However, a trigger signal can also be the reaching of a signal value in one or more sensor data or in a signal recorded by the measuring microphone, which indicate the reaching of a certain point in the time sequence; the reaching of a threshold value in one or more sensor data or in the signal of the measuring microphone; or the detection of a key word or key signal in a recorded acoustic signal (e.g. resulting from speech recognition).

In this way, the control matrix can then be modified and the functionality of the device can be adapted to the new conditions.

According to an embodiment, the following can serve as a trigger signal:
Sound data recorded by the measuring microphone,
sensor data from connected sensors;
video data or image data from image recognition;
speech data from speech recognition.

As already mentioned, FIG. 1. schematically illustrates the control matrix (SOTOS matrix) of the control program of the device according to an embodiment example.

According to one embodiment, the central control tasks of the system are implemented in this matrix, in particular who hears whom or what in which form via their intercom device. A matrix entry defines, for example, the type and extent to which information is output or forwarded from a connected user or a connected device X to another user or a connected device Y. A corresponding matrix entry is provided for each connected user or for each pair of connected users and/or devices. The matrix entry can also be complex and correspond to a processing instruction according to which input data is processed or converted and output data is generated. The matrix entry thus defines in particular who hears whom and in which form, and how received sound signals are forwarded to the users via their respective audio output devices.

According to one embodiment, the SOTOS extender, which can be connected to the SOTOS matrix, is another component of the system. It forms a further control matrix that implements an external team, for example. The SOTOS extender thus represents an extension system of the apparatus.

According to one embodiment, a log server records all output signals, logs them, monitors the procedure, generates a logbook and distributes the information to a database (shown as a SOTO DB), which for example has a connection to the digital hospital (DWH) example.

The input signals of the control matrix according to an embodiment can be the following:
Acoustic content (verbal or tonal, noises, sound sequences or noises to be described in terms of time, music of various genres, coded or compressed sound carriers), also electrical states and processes (e.g. voltages, current strengths,
pulses, time sequences, switch states) or electronically coded content (e.g. programming languages, hexadecimal codes, character strings, math. formulas).

Speech signals, for example, can be recorded using speech recognition and analyzed for key terms, which can then serve as trigger events for adapting the control matrix.

By means of the described embodiment, an environment can be created in the operating room that provides a protected experience space for the user. The protected experience space can be achieved by isolating (occluding) hearing systems from the noisy environment filled with acoustic information by means of active and passive noise suppression, each implemented by the control matrix.

Active noise suppression in the system can be static, but also dynamic, in that the changing noise situation in the working environment leads to a change in the noise filters controlled by algorithms. In this case, the changing noise situation is the “trigger signal” for adjusting the control matrix.

As described above, according to one embodiment, gates (or noise gates) can control the opening and closing of the intercom microphones used in the system. According to one embodiment, these gates are designed in such a way that, in addition to a static basic setting, the opening thresholds are automatically influenced by a control algorithm.

The control of these gates in the system can adapted such that the integration of the surrounding machines can lead to the thresholds or acoustic filters (passenger) being adjusted in real time in a predictive manner (promptly in response to future noise qualities). In this way, a schedule of the operation can be mapped in the control program, whereby a signal from a sensor indicates the occurrence of an event in this schedule. This can then be a trigger event that, for example, raises the threshold values of the gates (which corresponds to an adjustment of the control matrix) because, for example, a “loud device” is switched on according to the operation sequence. This can lead to an optimized noise protection adapted to the person reacting hoc.

However, a protected experience space can also be achieved by suppressing or amplifying other possible sensory perceptions in order to be able to use them individually with information relevant to the experience space. In addition to acoustic perceptions, sensory perceptions can also be visual and tactile or vibration perceptions, for which the output signals of the control matrix then control the corresponding actuators.

The function of the device and control matrix according to an embodiment is described in further detail below.

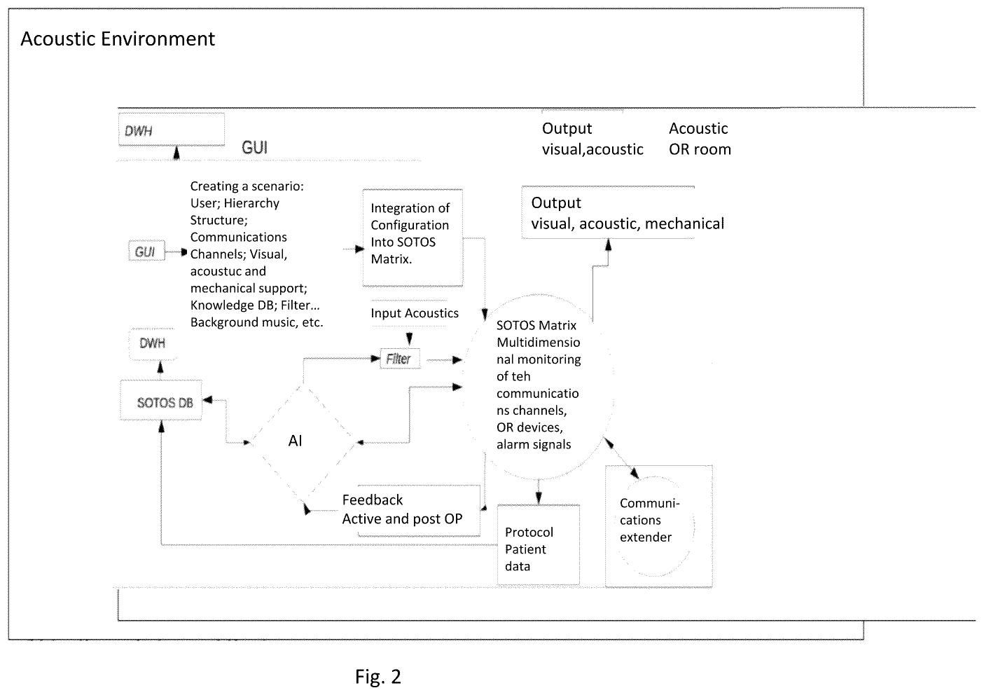

FIG. 2 illustrates the functionality of the device and the control matrix according to an embodiment. First, the working environment is configured using a graphical user interface (GUI) and loaded into the main module of the control program (shown as a SOTOS matrix or control matrix). The scenario, the users, possible visual and acoustic signals as well as the acoustic filters are configured and adapted to the working environment. The control program with its control matrix then takes over the information management. Specifically, the acoustic channels are monitored and managed on a user-specific basis. Visual, acoustic and mechanical inputs (alarm/info) are distributed to the relevant users. The entire acoustic performance is supported by the Al acoustic module, which implements adaptable filters, for example. Active filters are instantly learned and the acoustic working environment of the respective user is optimized. The system can also react to unforeseen noises (e.g. bangs, airplanes, etc.) and filter them to provide intelligent, dynamic, real-time hearing protection that automatically adapts to the environment. This is particularly possible if the parameters of the control matrix have already been configured or “learned” accordingly by storing the corresponding spectral patterns. This ensures that the stress level for the user is reduced to a minimum.

According to one example, the control program provides a connection to external communication. An Al module and a protocol module run during the entire working phase of the system. The Al module monitors and learns (e.g. by means of feedback from the user) and thus becomes better and better adjusted to unforeseen noises with each use. The protocol module monitors events, creates a logbook and supplements the digital patient database.

According to an embodiment, the apparatus represents or implements the most comprehensive possible digital image of the working environment of the operating room. The most comprehensive possible digital image of the working environment with people and machines and all circumstances and influencing factors that determine the work process, as well as spatial conditions, is recorded and created using self-learning control. For this purpose, the control program includes information about the time sequence of the operation in the operating room and the control matrix is adapted on the basis of this information when an input signal from the sensor data indicates a trigger event that represents the occurrence of an event in the time sequence of the operation.

In this way, the apparatus knows the objective of the work process to be controlled. According to an embodiment, the following parameters are used as input parameters for the control matrix, whereby these may be received by means of sensors:
a) verbal communication packages of all team members (who speaks, how loud, etc.)
b) traffic of team members (barcodes) recognizing team roles
c) traffic of equipment, devices, tools,
d) parameters of the climatic working environment and adjacent areas, i.e. e.g. information on temperature, pressure, pressure gradients for the environment, Status doors (open closed), light, humidity
e) status of relevant technology in the working environment (measured values, settings, condition, maintenance times, safety, running time, maintenance time, interactions, . . . )
f) dimension or status of current procedures and processes (timeline, productivity, dependencies on other processes, feedback

### Management,

h) language content (index words for process assessment and control of dependent processes, language control technology, processes, documentation)
i) video and images (facial recognition, e.g. also via barcode), assessment of situations, procedures to recognize and control dependent processes (e.g. anesthetist enters the room), documentation, video conferences, video calls
j) overall hierarchy of processes, persons, superordinate management, schedules, material planning
k) acoustic feedback from machines and activities (working noises, motor noises, tool noises, tire noises, gears, fans,

l) health data of people in the work environment (ECG, respiration, body temperature, blood pressure, SaO2, CO2 toxins, color temperature, posture, physical strain, movement)

The control program of the device records, evaluates, interprets, controls, plans and provides feedback to the users in the work area, controls interaction with the technology (e.g. switch on ECG), air conditioning, door statuses, etc. The system according to one embodiment example can also warn (alarm signal), guide (e.g. through visual information), place orders (request transport bed).

The multitude of sensors and their data are recorded and processed by the control matrix or control program, which then produces output according to the control program for forwarding to the user or for controlling devices. For example, a machine that is running hot, making certain noises and drawing more current is then caused to rotate more slowly. Or a person who has not taken a break for a long time, is tachycardic, breathes quickly and heavily and has a rare eyelid beat is exhausted and is in danger of making mistakes, is warned.

This is made possible by the sensor data and its processing by the control program and its adaptable control matrix, as well as by the mapping of the surgical procedure in the control program. For example, the request from the stapler in the operating room indicates that the skin is closed and the operation is about to be completed, which then triggers dependent processes such as personnel being called to the positioning aid. According to one embodiment, the patient's condition is also recorded, e.g. as a digital image from a large amount of data, vital signs, laboratory values, current medication doses per time, ventilation parameters, predicted operation duration, and depending on the sensor data, the corresponding output is then displayed by the control matrix or the control program, which is passed on to the users of the operating room or controls its functional devices.

In addition to application to the technical working environment of an operating room, as described above, the approach described can also be applied to other technical working environments. Examples include industrial production environments and laboratories. A “technical working environment” is an environment where information has to be transmitted and channeled between a large number of people and at the same time human-machine interaction takes place by controlling or monitoring measuring, monitoring or processing devices.

In an industrial production environment, the data recorded by the sensor devices and entered into the mixing device then includes, for example, acoustic feedback from machines, in particular working noises, motor noises, tool noises or signals from other sensors. Certain threshold values can then be used as trigger signals. For example, a pallet is monitored by a sensor. If the pallet on the machine is full according to the sensor signal that serves as a trigger signal, a new one is ordered in good time via the control matrix and corresponding output channels.

1. An apparatus for forming a computerized communication environment for a technical working environment, comprising:
a plurality of intercom devices with a microphone and an audio output, each of which is assigned to a person in the technical working environment, which is preferably a surgical operating room; wherein
the mixing device with the plurality of intercoms controls, for each pair of two intercoms connected to the mixing device, whether and in which direction a flow of information is enabled between the two connected intercoms;
wherein a control matrix is provided for controlling the flow of information, the matrix having a matrix entry defining the flow of information for each pair of devices connected to the mixing device, the apparatus further comprising:
a measuring microphone for measuring the ambient sound, which measures the sound level in the room; and wherein the mixing device comprises:
a computer-implemented control program executed by the mixing device, which dynamically adapts the matrix entries to the current situation in the technical working environment depending on the data supplied to the mixing device by the connected devices, the mixing device comprising:
a gate for each of the microphones of the intercom devices, which can amplify or suppress the sound entering one of the microphones of the intercom devices for transmission to the audio outputs of other intercom devices;
wherein the control program is adapted such that the amplification or suppression of the sound entering at a microphone and to be output to the audio outputs of the other intercom devices is dynamically adjusted by the gate depending on the analysis of the ambient sound measured by the measuring microphone.

2. The apparatus of claim 1, wherein
the mixing device controls the gate on at least one of the intercom devices in such a way that it forwards the incoming sound to audio outputs of the other intercom devices when it is at or above a certain minimum sound level, wherein the minimum sound level is adjusted depending on the sound level of the room measured by the measuring microphone.

3. The apparatus of claim 2, wherein a user's speech is fed into his own audio output if it has the minimum sound level and is forwarded to the audio outputs of the other users.

4. The apparatus of claim 1, wherein the gate has one or more of the following functions, preferably depending on the input signal:
completely block or completely pass through the input signal coming into the microphone to the audio output of one or more of the other intercom devices;
amplification or suppression of the input signal, preferably in a non-linear relationship between amplification or suppression and input signal strength;
limitation of the output signal to a maximum signal strength and/or output of the output signal with a minimum signal strength.

5. The apparatus of claim 1, the mixing device further comprises:
an analysis device for spectral analysis of the sound arriving at the measuring microphone, wherein
the mixing device is adapted such that when a predetermined spectral pattern is recognized by the gate of an intercom device, one or more spectral components corresponding to the recognized spectral pattern are amplified or suppress.

6. The apparatus of claim 1, wherein the mixing device further comprises:
A device for feeding the ambient sound received by the measurement microphone into the audio output of one or more of the intercom devices.

7. The apparatus of claim 6, wherein the sound level at which the ambient signal is fed into the audio output is dynamically adjusted in response to a request from the user or an external trigger signal detected by an analyzer of the mixing device.

8. The apparatus of claim 1, wherein an individual hearing correction curve is stored in the device for one or more users and the audio output on the user's intercom device is controlled by the mixing device in such a way that the audio signal output to the user is adapted in accordance with the stored hearing correction curve.

9. The apparatus of claim 1, wherein a plurality of devices are connected to the mixing device, comprising:
a plurality of functional units used for the fully or semi-automatic performance of a function in the technical working environment,
a plurality of sensors that detect parameters of the state of the technical working environment, of functional units present in the technical working environment, and parameters of the state of persons present in the technical working environment;
wherein the mixing device controls which information is output from the mixing device to one of the connected devices.

10. The apparatus of claim 1, wherein the technical working environment is one of the following:
a surgical operating room;
a production room in an industrial manufacturing facility;
a laboratory for the scientific or industrial analysis of chemical or physical processes or substances,
a control room for monitoring or controlling an industrial production process, an open-plan office,
a conference environment.

11. The apparatus of claim 9, wherein when the signals received in the mixing device from connected devices indicate a trigger signal, a change in the matrix data is made.

12. The apparatus of claim 10, wherein
the control program comprises information about the timing of the operation in the operating room, and based on this information, when an input signal of the sensor data indicates a trigger event representing an occurrence of an event in the timing of the operation, the control matrix is adjusted.

13. The apparatus of claim 11, wherein the trigger signal is one of the following:
the reaching of a signal value in one or more sensor data indicating that a specific point in the time sequence has been reached;
the reaching of a threshold value in one or more sensor data;
the detection of a keyword or key signal in a recorded acoustic signal;
an input from the user to learn a new situation.

14. The apparatus of claim 1, wherein
The control program is implemented in whole or in part by means of a neural network that receives the signals from the plurality of sensors as input and supplies the control matrix as output. The neural network is preferably trained using data from real operating situations and thus continues to adapt to the needs of the user and to new situations.

15. The apparatus of claim 1, wherein the input signals of the control matrix comprise speech signals which are detected by means of speech recognition and examined for key words, wherein a key word represents a trigger signal.

16. The apparatus of claim 11, wherein the trigger signal for adjusting the control matrix is one or more of the following:
Sensor data from connected sensors;
video data or image data from image recognition;
speech data from speech recognition.

17. The apparatus of claim 16, wherein the data sensed by the sensors and input to the mixing device comprises:
Acoustic feedback from machines, in particular working noises, motor noises or tool noises.

18. The apparatus of claim 1, wherein connected sensors identify the function of a user within a user group, in particular by means of a barcode or QR code, and based on the function of the user, only those data are transmitted from the mixing device to the user that are relevant according to his function and a hierarchy or function chart.
